(19) United States
(12) Patent Application Publication
(10) Pub. No.: US 2007/0203869 A1
(43) Pub. Date: Aug. 30, 2007

(54) Adaptive semantic platform architecture

(75) Inventors: William D. Ramsey, Redmond, WA (US); Sanjeev Katariya, Bellevue, WA (US); Jun Liu, Bellevue, WA (US); Jianfeng Gao, Redmond, WA (US); Qi Yao, Sammamish, WA (US); Zhanliang Chen, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/363,747

(22) Filed: Feb. 28, 2006

(51) Int. Cl. G06N 7/02

(52) U.S. Cl. 706/52

(57) ABSTRACT

An adaptive shared infrastructure that can be easily utilized to enable natural interaction between user(s) and machine system(s) is provided. Additionally, the novel innovation can provide interactive techniques that produce accurate intent-to-action mapping based upon a user input. Further, the innovation can provide novel mechanism by which assets (e.g., documents, actions) can be authored. The authoring mechanisms can enable the generation of learning models such that the system can infer a user intent based at least in part upon an analysis of a user input. In response thereto, the system can discover an asset, or group of assets based upon the inference. Moreover, the innovation can provide a natural language interface that learns and/or adapts based upon one or more user input(s), action(s), and/or state(s).

### BACKGROUND

Human languages are rich and complicated and include hundreds of vocabularies with complex grammar and contextual meanings. By way of example, a particular statement, question, thought, meaning, etc. can be expressed in a multitude of different manners. Thus, machine interpretation of the human language is an extremely complex task. For at least this reason, oftentimes, the result or action produced from a human input does not accurately map or correspond to the user intent.

Machine or software applications and languages generally require data to be input in accordance with a specific format or rule. Humans desiring to interact with the machine sometimes become frustrated or unable to communicate effectively due to the rigid rules and the unfamiliarity or lack of knowledge of such rules. Providing users the ability to communicate effectively to an automated system without the need to learn a machine specific language or grammar increases system usability. However, users can become quickly frustrated when automated systems and machines are unable to correctly interpret the user input, which can produce an unexpected result, an undesired result, and/or no result at all.

Natural language input can be useful for a wide variety of applications, including virtually every software application with which humans interact. Typically, during natural language processing the natural language input is separated into tokens and mapped to one or more actions provided by the software application. Each software application can have a unique set of actions, which are somewhat limited in nature. As a result, it can be both time-consuming and repetitive for software developers to draft code to interpret natural language input and map the input to the appropriate action for each application.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises an adaptive shared infrastructure that can be easily utilized to enable natural interaction between user(s) and machine system(s). Additionally, the novel innovation can provide interactive techniques that produce accurate intent-to-action mapping based upon a user input. Further, the innovation can provide novel mechanism by which assets (e.g., documents, actions) can be authored. As such, “assets” that can be retrieved into two classes: “documents” are assets that are static and “actions” are assets that are dynamic and can perform the action.

The authoring mechanisms can enable the generation of learning models such that the system can infer a user intent based at least in part upon an analysis of a user input. In response thereto, the system can discover an asset, or group of assets based upon the inference. Moreover, the innovation can provide a natural language interface that learns and/or adapts based upon one or more user input(s), action(s), and/or state(s).

Essentially, in one aspect, the novel innovation can include an architecture of a statistically-based system that has the ability to align intents to actions and can learn from users' behavior to improve over time. More particularly, the architecture can encompass an end-to-end system that covers:
Authoring of assets;
Determining a users intent;
Mapping the intent to an asset or set of assets;
Executing the asset(s);
Obtaining feedback; and
Learning from the feedback.

In other aspects, the novel intent-to-action system can be applied to make interaction between humans and machines more natural in scenarios including, but not limited to, a speech application running on a server, a smaller application running on a mobile phone, a desktop application running on a personal computer, or a web service running over the Internet.

The subject architecture can significantly lower the cost of having natural features in applications by providing a common end-to-end infrastructure from authoring to reasoning to feedback. This architecture is versatile and can be used in scenarios including, but not limited to, speech, desktop, mobile, and web applications. As well, the architecture can provide simple application program interfaces (APIs) to do so.

In accordance with an aspect, there can be three major flow (logic and data) diagrams. The architecture supports the three listed end to end flows including a model construct and management flow, a user interaction flow and a feedback and analysis flow.

In yet another aspect thereof, an artificial intelligence component is provided that employs a probabilistic and/or statistical-based analysis to infer an intent or action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates intent-to-action interactions in accordance with an aspect of the innovation.

FIG. 2 illustrates an exemplary flow chart of procedures that facilitate determining a task based upon a user input in accordance with an aspect of the innovation.

FIG. 3 illustrates an exemplary flow chart of procedures that facilitate authoring a task in accordance with an aspect of the innovation

FIG. 4 illustrates a block diagram of a reasoning component in accordance with an aspect of the innovation.

FIG. 5 illustrates a block diagram of an authoring/analysis component in accordance with an aspect of the innovation.

FIG. 6 illustrates a block diagram of a data store that facilitates maintaining asset information in accordance with an aspect of the innovation.

FIG. 7 illustrates an alternative block diagram of an adaptive semantic platform architecture in accordance with an aspect of the innovation.

FIG. 8 illustrates an exemplary graphical user interface (GUI) task wizard that facilitates authoring a task in accordance with an aspect of the innovation.

FIG. 9 illustrates an exemplary telephone directory authoring GUI in accordance with an aspect of the innovation.

FIG. 10 illustrates an exemplary text extractor component that facilitates automatically authoring a webpage related task in accordance with an aspect of the innovation.

FIG. 11 illustrates an exemplary GUI representation that generates explicit feedback in accordance with an aspect of the innovation.

FIG. 12 illustrates an exemplary GUI representation that generates implicit feedback in accordance with an aspect of the innovation.

FIG. 13 illustrates a block diagram of a computer operable to execute the disclosed architecture.

FIG. 14 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

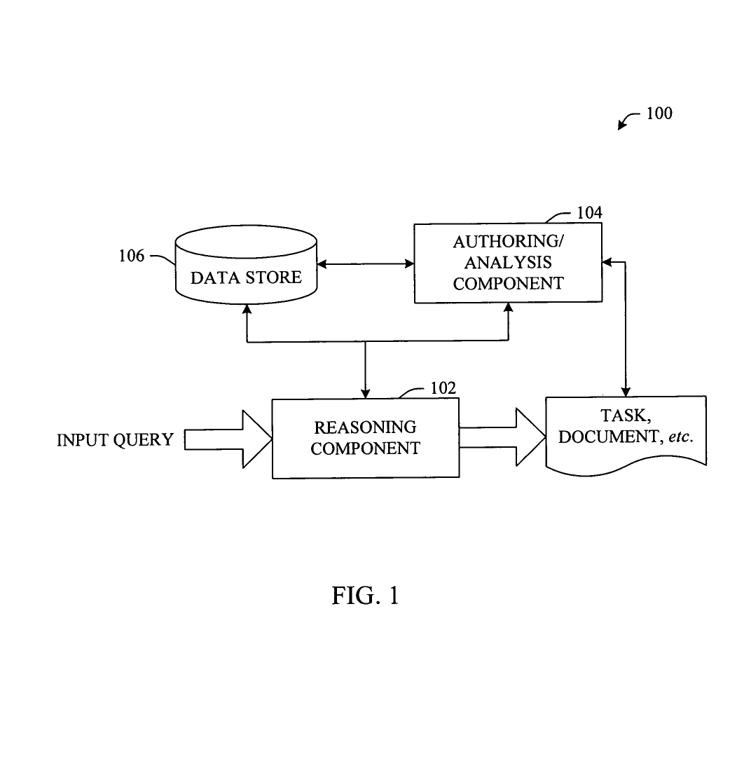

Referring initially to the drawings, FIG. 1 illustrates a system 100 that facilitates natural and intuitive interactions between a user and a machine. Generally, the system 100 can include a reasoning component 102, an authoring/analysis component 104 and a data store 106. More particularly, system 100 can receive an input query from a user (or application) thereafter processing the query by employing the reasoning component 102. In operation, the reasoning component 102 can parse the input into a set of tokens that can be processed and interpreted in order to render an appropriate task to the user.

The authoring/analysis component 104 and the data store 106 can each be employed to establish and facilitate tasks in response to a particular user input. It will be understood upon a review of the figures that follow that the input query can be of any form, including, but not limited to, text and speech, or the like. Each of the aforementioned components of system 100 will be described in greater detail infra. While specific aspects and examples are described below, it is to be understood that an unlimited number of inputs as well as tasks can be applied to the novelty of the innovation. As such, these alternative aspects are to be included within the scope of the disclosure and claims appended hereto.

As described above, a determination of user intent from natural language queries is one of the most difficult problems in computer science. For example, a user can be searching for help documents, samples of similar work, for websites containing the input information, or possibly even something that will perform the action. Given that the amount of information that users attempt to find is virtually infinite, the subject innovation categorizes the types of “assets” or “tasks” that can be retrieved into two classes: “documents” and “actions.” As such, documents refer to assets that are static and “actions” are assets that are dynamic and can perform a particular action.

It will be appreciated that, one problem posed to and not solved by conventional systems is to somehow find an asset that matches users' “intents”. In accordance therewith, the subject system 100 architecture can perform as a statistically-based system that has the ability to align intents to actions and can learn from user behavior to improve and become more accurate over time.

By way of example and with reference again to FIG. 1, a user can speak or type an input query that represents whatever they want to do or locate. Accordingly, in one aspect, the reasoning component 102 can map the instruction into documents that are useful or into actions that can be performed on the user machine, each based upon the input query.

In addition to dynamically interpreting an input query, the subject framework or architecture (e.g., system 100) can include an authoring/analysis component 104 that can enable authoring or creating an application (e.g., task, action) that can handle arbitrary input. As well, the architecture (system 100) can determine a user preference in accordance with any arbitrary input.

It will be understood and appreciated that a hard-coded system is very difficult to update and maintain. Hard-coded systems require a predetermined mapping of every possible input to a particular task, action, document, etc. Additionally, as arbitrary inputs change, the hard-coded system too would have to be modified in order to build upon ever-changing range of inputs. In contrast to traditional hard-coded systems, the subject innovation is a statistically-based system that can require very little, if any at all, hand tuning. In other words, the subject innovation can automatically build upon user inputs and results thus eliminating the any need for human intervention and/or maintenance.

More particularly, the system 100 can exploit the massive amount of data available, for example via the internet and within call centers. This massive amount of data can be leveraged to learn what users are doing by exploring the mapping of user inputs to actions. As will be understood upon a review of the figures that follow, the subject system 100 can employ the authoring/analysis component 104 to effectuate a novel feedback-based system.

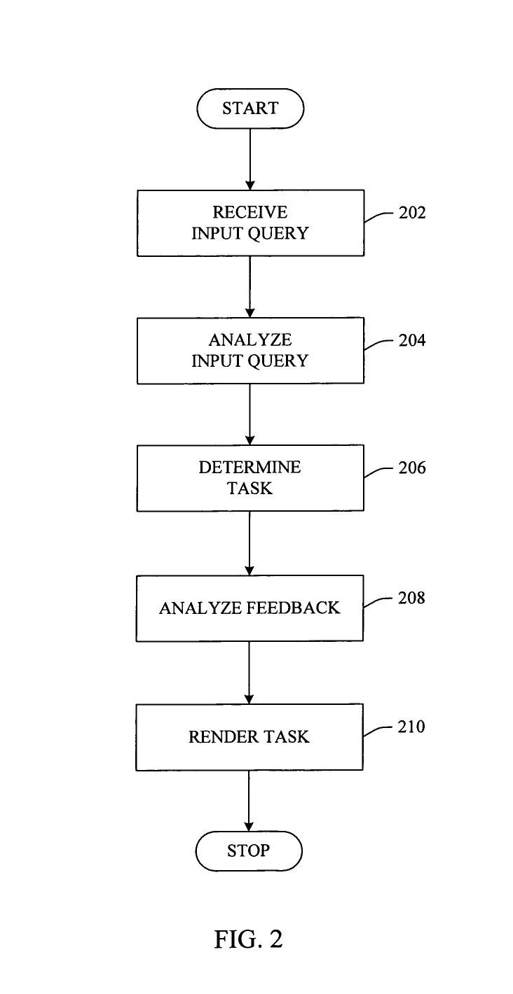

FIG. 2 illustrates a methodology of processing a user input in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, an input query can be received that represents a user query. In one aspect, the input query can be an alphanumeric string that includes search terms pursuant to a user inquiry. In another aspect, the input query can take the form of a spoken query. It will be understood that any method of input can be employed without departing from the scope of the innovation.

While the method of input may differ, it will be understood that one novel feature of the innovation is the analysis of the input query at 204. As such, the input query can be parsed or separated into tokens (e.g., search terms). These search terms can be employed at 206 to determine a relevant task in accordance with the input query. In other words, the system can analyze the input query at 204 and thereafter employ the result of the analysis to determine an appropriate task at 206.

Once a task is determined, feedback can be analyzed at 208 in order to further automate the employment of a task in accordance with a user intention, history, etc. By way of example, a slot auto-fill can be employed in order to dynamically automate a user intention by pre-populating input boxes relative to the selected task. Once the feedback has been analyzed and implemented as appropriate, the task can be rendered to a user at 210. It is to be understood that the process of rendering tasks and compiling feedback can be a recursive process such that information (e.g., feedback) can be continuously gathered, stored and utilized in order to build upon interactions thereby increasing the interactivity and capabilities of the system.

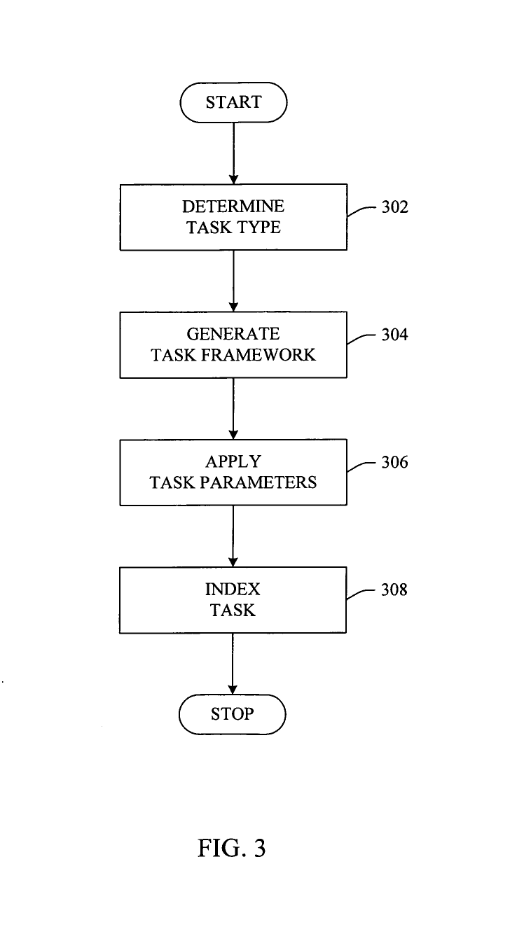

Turning now to FIG. 3, a methodology authoring a task in accordance with an aspect of the innovation is shown. As will be understood, the architecture shown in FIG. 1 can facilitate a process from authoring a task to determining a user intent and finally to mapping the intent to a particular asset or task. By way of example, the asset can be a particular document, a help document on a particular subject or an action that user prefers to perform (e.g., opening an email and pre-loading specific fields). In accordance therewith, the methodology shown in FIG. 3 illustrates an exemplary process flow to initially author a task.

At 302, a type of task can be determined. For example, a task can be developed that is associated to a particular type of action (e.g., creating a table). As such, the general framework of the task is generated at 304. Once the framework is established, task parameters can be applied to the framework at 306.

In a more specific example, suppose the task is directed to creating a table in a word processing document. Accordingly, the parameters can be factors such as a number of rows, a number of columns, column width, etc. Finally, once authored, the task can be indexed in a store at 308 such that the task can be retrieved at a later date in response to a user inquiry. Finally, a stop block is reached.

Turning again to the system 100 architecture shown in FIG. 1, the system can provide an architecture that not only selects an asset (e.g., task) but, also determines how an asset is to be executed in accordance with a user input. In other words, the innovation can control how an action is performed and where the handoff is from the subject innovation and the target system. Accordingly, this information can be employed to provide feedback into the system. It is to be understood that feedback in this example can be loosely defined as whatever a user has done with respect to a particular action.

In a specific example, a speech application can be employed to interpret a query for booking a flight where a destination city can automatically be filled out (e.g., Pittsburgh). This auto-slot fill can be based upon any criteria including but, not limited to, a past user action.

Continuing with the example above, in response to a user query that indicates a desire to book a flight to Pittsburgh, the system 100 can automatically perform a task by accessing a particular Internet website to book the flight. In accordance therewith, the reasoning component 102 can be employed to automatically fill in the destination city field to be “Pittsburgh.” Further, the system (via the authoring/analysis component 104) could record this information (e.g., accessing the website and filling in the destination city) as feedback to be used in connection with the same or similar subsequent actions.

All in all, the system can leverage feedback to learn and become more advanced and more responsive to a user input. As shown in FIG. 1, the architecture of system 100 can encompass an end-to-end system that includes the following:
Authoring of an asset;
Determination of a user intent;
Mapping the intent to an asset;
Execution of the asset;
Obtaining feedback; and
Learning from feedback.

It is to be understood that “intent to action” is a recurring theme in applications. Whether a speech application running on a server, a smaller application running on a mobile phone, a desktop application running on a personal computer, or a web service running over the Internet, users have consistently shown a desire to make interaction with computers more natural—“intent to action” can facilitate accomplishing this goal.

Conventionally, a framework or system does not exist to convert intent to action and to monitor feedback with respect thereof. The novel system 100 described herein can significantly lower the cost of having natural features in applications by providing a common end-to-end infrastructure from authoring to reasoning to feedback. This system 100 can be used by speech, desktop, mobile, and web applications as well as can provide simple application program interfaces (APIs) to do so.

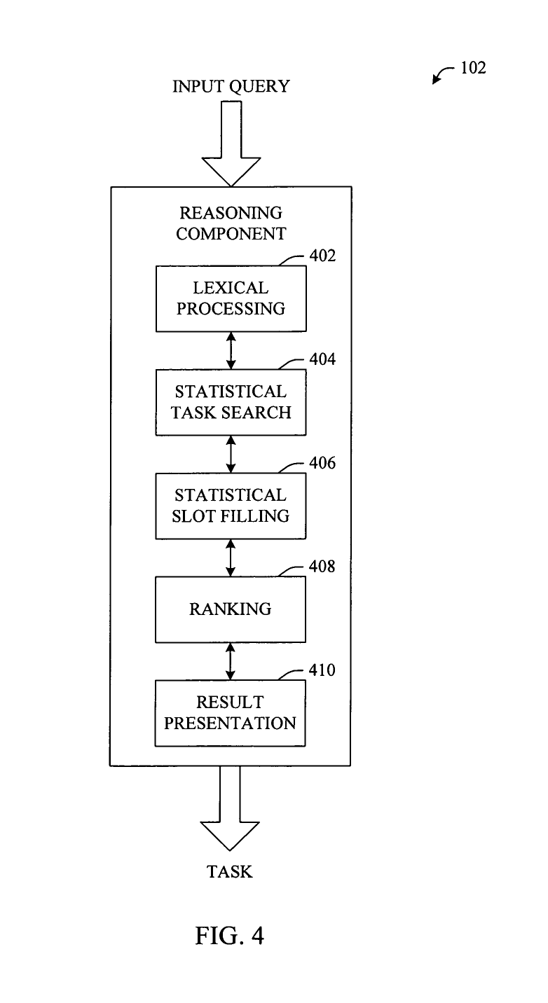

There are at least three major flow (logic and data) diagrams supported by the system 100 architecture. Each of the flows can be described with reference to the novel components of system 100. FIGS. 4-6 illustrate detailed block diagrams of a reasoning component 102, an authoring/analysis component 104, and a data store component 106 respectively. As will be understood, these components can effectuate the three disparate flows described below.

First, the system 100 can facilitate a Model Construction and Management Flow. Generally, this is the flow which is concerned with the creation and management of assets—tasks, documents and hierarchies (taxonomies). More particularly, this is the part where assets (e.g., tasks, documents) are created, annotations are created that help the reasoning system, feedback data is incorporated to train learning models, and intermediate and runtime indexes (inverted indexes, property stores) are created. In operation, the authoring/analysis component 104 and the data store 106 can be employed to effectuate this flow.

Second, the system 100 can facilitate a User Interaction Flow. Generally, this is the flow which is concerned with the user interaction with the system. More particularly, this is where the user interaction is expressed with the modality of choice (e.g., speech, text) and context (e.g., code or data). In operation, the system reasons over the “asset space” providing ranked semantic solutions back to the application space and the application presents supporting user interface elements (e.g., dialogs, restatements, confirmations, end assets, execution sequences) that assist the user to map their intent to an action with the highest possible “customer satisfaction.” Additionally, this flow is where the application interfaces with the system through an API set and gets back data result sets that lead to execution or enumeration—based on the asset type. In operation, the reasoning component 102 can be employed to facilitate this novel functionality.

Third, the system 100 can facilitate a Feedback and Analysis Flow. This is the flow which is concerned with gathering feedback and then later analyzing the gathered feedback to create a better user and model construction flows—seeking to improve the development and interaction experiences. Again, the authoring/analysis component 104 along with the data store 106 can be employed to effectuate this portion of the flow.

Referring now to FIG. 4, illustrated is an exemplary block diagram of a reasoning component 102. As shown, the reasoning component 102 can include a lexical processing component 402, a statistical task search component 404, a statistical slot filling component 406, a ranking component 408 and a result presentation component 410. Each of these components will be described below with respect to their novel functionality. While the reasoning component 102 is illustrated and includes each of these disparate components, it is to be understood that any subset of these components can be omitted from the reasoning component without departing from the overall novel functionality of the innovation.

In operation, the reasoning component 102 can process an input query through task execution. Following is a discussion of particular examples directed to a travel-related input query. While these examples are provided to add context to the innovation, it is to be understood that these examples are not intended to limit the innovation in any way. Rather, the examples described herein are provided to add perspective to the description of the innovation and those skilled in the art will appreciate that an unlimited number of additional examples exist that are to be included within the scope of this disclosure and claims appended hereto.

In an example, the input query could be a spoke or typed phrase, “I want to go from Pittsburgh to Seattle.” For instance, this phrase could be entered into a search engine. Upon receiving the input, the reasoning component 102 can process the input by employing a lexical processing component 402. More particularly, lexical processing component 402 can parse the query into a set of tokens. In other words, the lexical processing component 402 can perform a word breaking procedure upon the input.

Although this aspect employs word breaking to parse the input, it will be understood that a variety of tools can be used to separate the words of an input. Upon breaking the words, the lexical processing component 402 can discover named entities (e.g., Pittsburgh, Seattle) included within the input query. Named entities are to be understood to be words that have a particular meaning to a particular domain. By way of further and more specific example, suppose the input was “I want to go from Pittsburgh to Seattle on Nov. 13, 2006,” the system could also recognize the date/time input as a named entity (e.g., Nov. 13, 2006).

It will be understood that the named entities can be used to normalize a user characteristic. In the example above, the date format used can identify a user preference with respect to dates and thereafter determine what region of the query is directed to a date, city, etc. Once the system has the tokens from the word breaking and has the recognized named entities, the system can employ a statistical task search component 404.

In other words, from all of the available actions and documents, which are the most likely given the query and recognized named entities, the statistical task search component 404 can be employed to discover the most appropriate task, or set of tasks. In order to accomplish this novel task search, the innovation can employ a query classifier, an information retrieval, a content classifier or the like.

For example, today, many search engines employ an information retrieval mechanism to return and render results with respect to a search query. In other words, it will be understood that information retrieval mechanisms determine how to map a particular set of words to a particular document. However, these conventional uses of information retrieval are a tuned hard-coded system and are not based upon a novel statistical adaptive method as employed by statistical task search component 404.

Additionally, the statistical task search component 404 can employ a query classifier that determines what results have been returned by what queries. With respect to the aforementioned example, the query classifier can discover that the word “flight” in a query most often results in a user selecting a particular website. Therefore, the query classifier can “learn” that the word “flight” is associated with the name of a particular website or group of websites. Thus, the results from the information retrieval system can be tweaked to render a different result set or a different ranked result set based upon this learned reasoning.

Additionally the statistical task search component 404 can employ a context classifier that can evaluate a history of user actions and determine a user preference based upon the historical data. Continuing with the above example, with reference to the query, the context classifier can look at historical actions to determine that when a user enters a particular query, it is more likely that they are looking for flights rather than hotels, for instance. To this end, the context classifier can further assist in narrowing down a user preference or intent based upon gathered statistical data. All in all, the statistical task search component 404 can return a list of actions and/or documents that are determined via an analysis of a user input query.

Turning now to the statistical slot filling component 406, this component can perform an auto-fill of desired parameters and/or information criteria. With reference again to the flight example, the slot filling component 406 can auto-fill criteria such as time of flight, arrival city, destination, etc. all of which can be based upon, or determined from, a user preference or intent. All in all, the statistical slot filling component 406 can auto-fill particular slots based upon an input query.

In accordance therewith, the statistical slot filling component 406 can include a class model component, tag model component or the like. Although specific mechanisms of slot filling are disclosed, it is to be understood and appreciated that alternative mechanisms of slot filling can be employed in connection with the subject innovation. These alternative algorithmic mechanisms are to be included within the scope of this disclosure and claims appended hereto. In operation, the system can employ tasks identified by the statistical task search 404 in order to auto-fill appropriate slots.

A ranking component 408 can be employed to rank the identified tasks. It is to be understood that the tasks might be serviced from a variety of sources. For example, some tasks can be sourced from one website where others can be sourced from another and so on. Accordingly, it may be possible to source the tasks as appropriate in order to get results with respect to the best tasks from the best source(s) available. Accordingly, the ranking component 408 can combine the results from a variety of sources thereafter presenting the best results to a user.

The result presentation component 410 can render the results (e.g. task(s)) in a variety of manners. By way of example, the result presentations can vary from a simple search result presentation to a voice-activated system (e.g. “press one to book a flight”, “press two to for flight status”). It will be-appreciated that the presentation can be dependent on a number of variables, including but not limited to, device type, modality (e.g., speech, text), etc.

Once a user selects an option or a link, the system can enter the task execution phase. As is to be understood, the task execution and the input query are on the application side. In other words, these components are not tied to the backend processes that perform the processing and determine likely tasks, slot filling, etc. In other words, the application determines how it would prefer to render the task and how it should be executed (e.g., carried out). Within the task execution, the user might be taken through a web form, speech dialog, etc. Continuing with the flight example, the system 100 can prompt a user to input or confirm the departure city, the arrival city, etc.

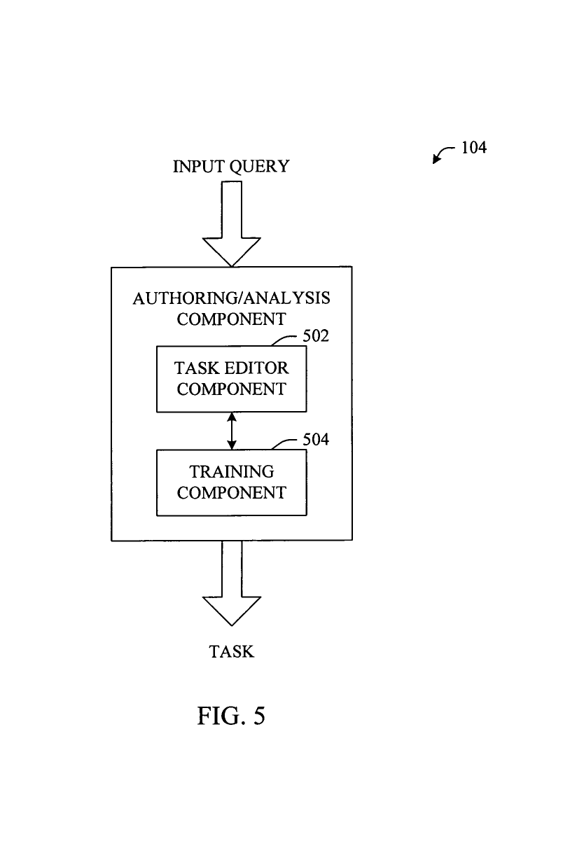

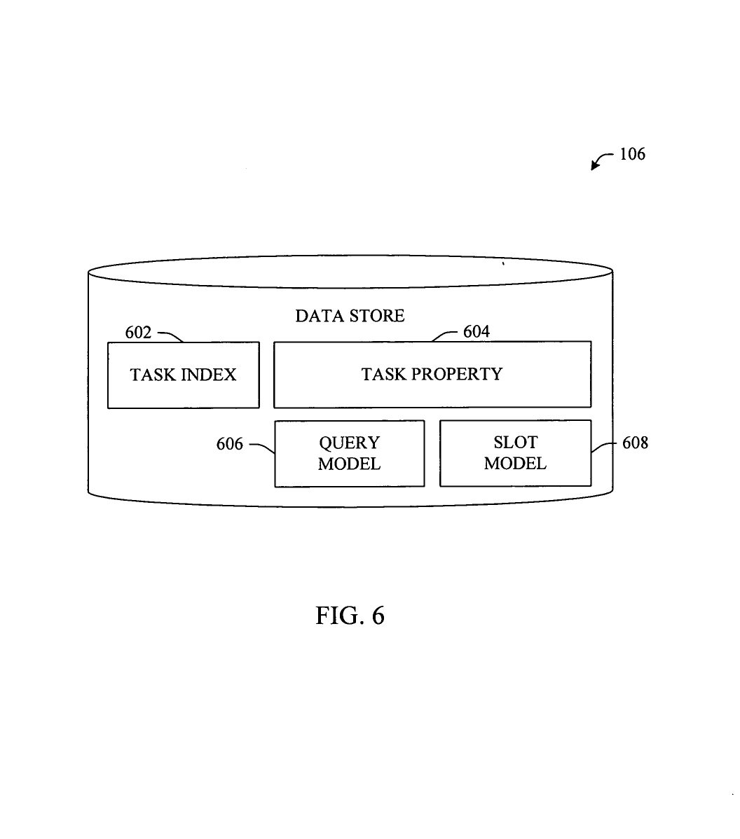

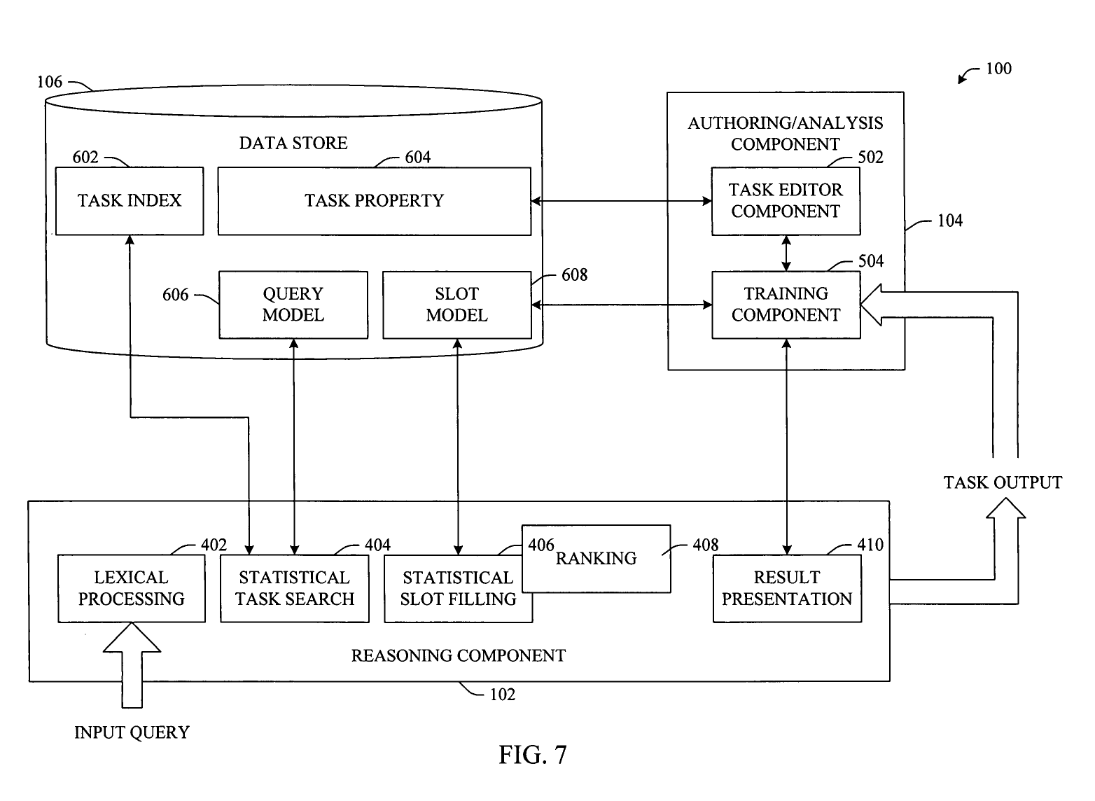

FIGS. 5 and 6 illustrate an exemplary authoring/analysis component 104 and data store component 106 respectively. Generally, the authoring/analysis component 104 can include a training component 502 and a task editor component 504. Among other information, the data store component 106 can include a task index component 602, a task property component 604, a query model component 606 and a slot model component 608. Each of these components and respective sub-components will be described in greater detail below with reference to FIG. 7.

Turning to FIG. 7, an alternative architectural diagram of system 100 is shown. More particularly, the alternative architectural diagram illustrates the sub-components inclusive of the reasoning, authoring/analysis and data store components (102, 104, 106). In operation, the system 100 can pass feedback into the system. This passing of feedback is illustrated by the arrow from task output (e.g., execution) to the training component 504. This arrow denotes feedback with respect to what the user did, what the query was, etc. Accordingly, this feedback can be passed back into the system to build the statistical models.

As shown in FIG. 7, the training component 504 can feed back into the slot model 608 and the query model 606 which can be used via the statistical task search and slot filling components (404, 406) to update the task search and slot filling boxes. As shown, there can be a feedback loop from the task output to the training component 504 (model builder) to the slot model 608 and the query model 606 which can communicate to the statistical slot filling component 406 and the statistical task search component 404 respectively. This loop illustrates how the system 100 responds to more data and how it builds upon information over time by building better models (606, 608).

Turning now to a discussion of the task editor component 502, task property component 604 and the task index component 602, initially before there is any data, authoring can be effected in order to tell what the domain can do or what the range of assets are—this is called authoring. In other words, authoring can be thought of as creating this context with respect to the domain.

Referring again to the flight example, the first step could be to author what users can do. For example, the task editor component 502 can be employed to generate tasks that enable users to book flights, check flight status, talk to customer service agent, inquire pricing, etc. Each of these items can be included within a list of tasks.

Additionally, the task editor component 502 can be employed to define parameters for each of these tasks. By way of example, booking flights can include parameters such as, destination city, arrival city, time of day and number of passengers. As shown, this information can be stored within the task properties 604 in the data store 106. As well, a task index 602 can also be stored within the data store 106. This stored information can provide a starting point for the system 100 with respect to the domains and the types of queries that users might employ to map into those domains.

Turning now to a brief end-to-end walkthrough with regard to the authoring/analysis component 104. It is to be understood that this walkthrough is provided to add perspective to the innovation and is not intended to limit the scope of the innovation in any way. In operation, the authoring/analysis component 104, and more particularly the task editor component 502, can be employed to author tasks with respect to any modality (e.g., speech, graphical user interface (GUI) text).

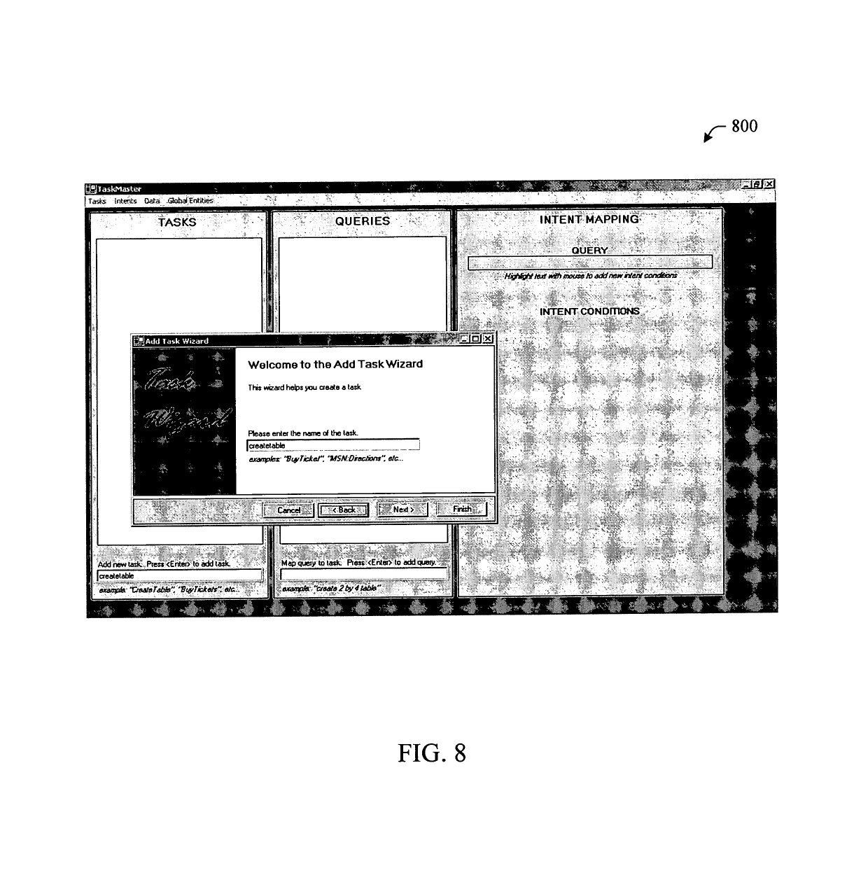

FIG. 8 illustrates an exemplary GUI task wizard 800 in accordance with an authoring aspect of the innovation. This task wizard can enable a user to create tasks which are assets that have parameters (e.g., book a flight). As shown in the exemplary screen shot 800, a “createtable” task is being authored. This “createtable” task can enable a table to be created in a word processing application and will be described in greater detail with reference to the figures that follow.

In accordance therewith, the parameters can be the number of rows, columns, etc. In operation, the task wizard 800 can guide a user through the process of creating a mapping and the task, including the parameters. Basically the innovation enables a user to create a task and also enables the user to define how the system responds to actual user feedback with respect to creating a particular task.

The authoring/analysis component 104 ties into both how to create a task as well as to how the system responds with respect to the models once data is present. It will be appreciated that, for speech call flows, a different authoring paradigm is employed. In other words, the authoring is directed to speech dialogs such as “welcome to ABC airlines.”

Although this disclosure has described a process (and components associated therewith) directed to processing an input query to arrive with a task, it is to be understood that development can begin in this architecture 100 with the developer authoring “tasks” (and slot associations) within an application space. In accordance therewith, the application space can be web-centric or desktop-centric since, in one aspect, the system 100 can represent tasks via XML. As well, one method of mapping to code from the manifest is application code domain dependent (e.g., web services or CLR).

As illustrated in FIG. 8, a task can be authored using a “Task” authoring tool. In other words, the authoring/analysis component 104 can basically be a tool that helps construct a task schema with its slots and recognizers. Accordingly, these tasks can be exposed through interfaces, whether web or CLR or COM, making it possible to integrate these tasks with the native code environment.

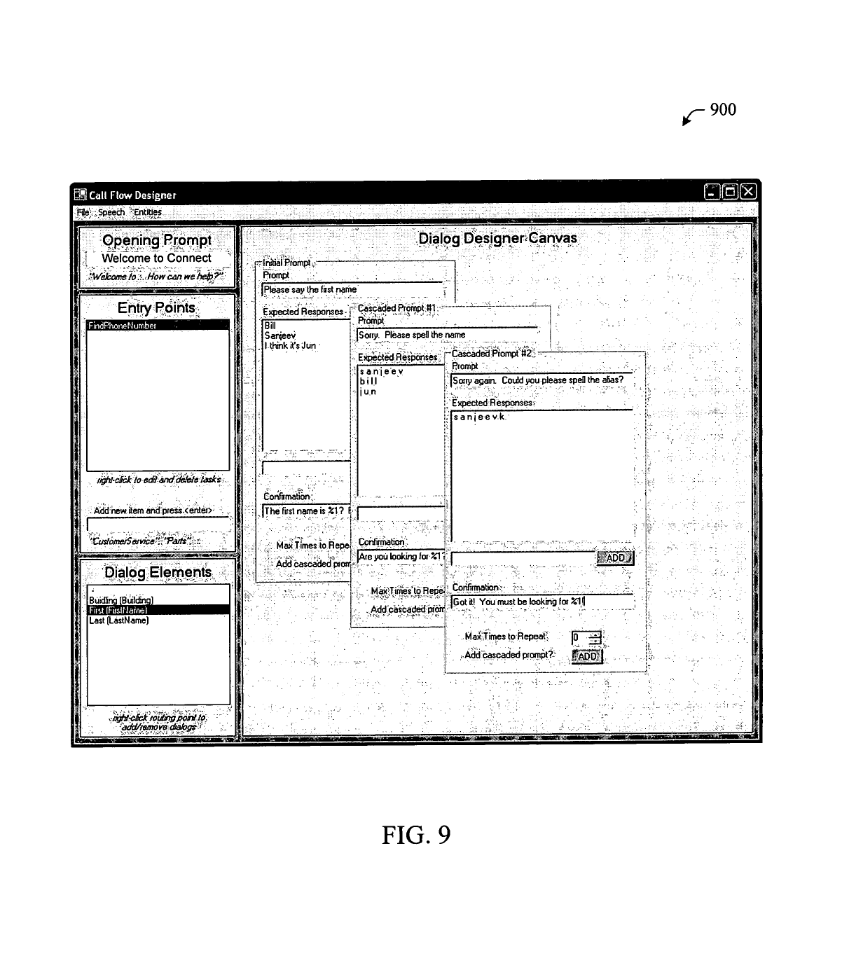

Referring now to FIG. 9, an exemplary phone directory authoring GUI is shown. In particular, the system 100 can be designed to prompt by stating, “Welcome to Connect.” Next, the system can prompt for the first name of the person that a user wishes to contact. If not recognizable, the system can prompt for the user to spell the name. If still not available, the system can prompt for another descriptive criterion such as email alias. As shown, the system can be programmed to continue to cascade down to extract information until a positive match is made.

In another example, speech call flows can be employed. In the case of authoring for speech applications, the user can have another tool that builds on the task framework but presents a different “visual” flow form. The different “visual” flow form can be directed toward supporting dialog flow, prompt design, grammar generation, and mixed and directed initiatives.

In this speech flow aspect, development still begins with the end task but the slots are presented as dialog elements. There can be proper UI design for the initial prompt, the directed slot dialogs, support for mixed initiative, cascading and failure prompt design. Additionally, there can be the ability to tie each “state” transition in call design flow to be tied back to an event handler in the application code space. This relationship affords the application the ability to “manage” the textual input actively to help in synthesis.

Additionally, once the dialog flow has been managed, there can be a tool (e.g., authoring/analysis component 104) that takes the input and maps it to speech formats (e.g:, SRGS). Additionally, the tool can also generate the associated recognition grammars with respect to each dialog element. One novel feature of this tool is that the textual training can be applied to this dialog flow/prompt design tool since both spaces are trained on text (or speech).

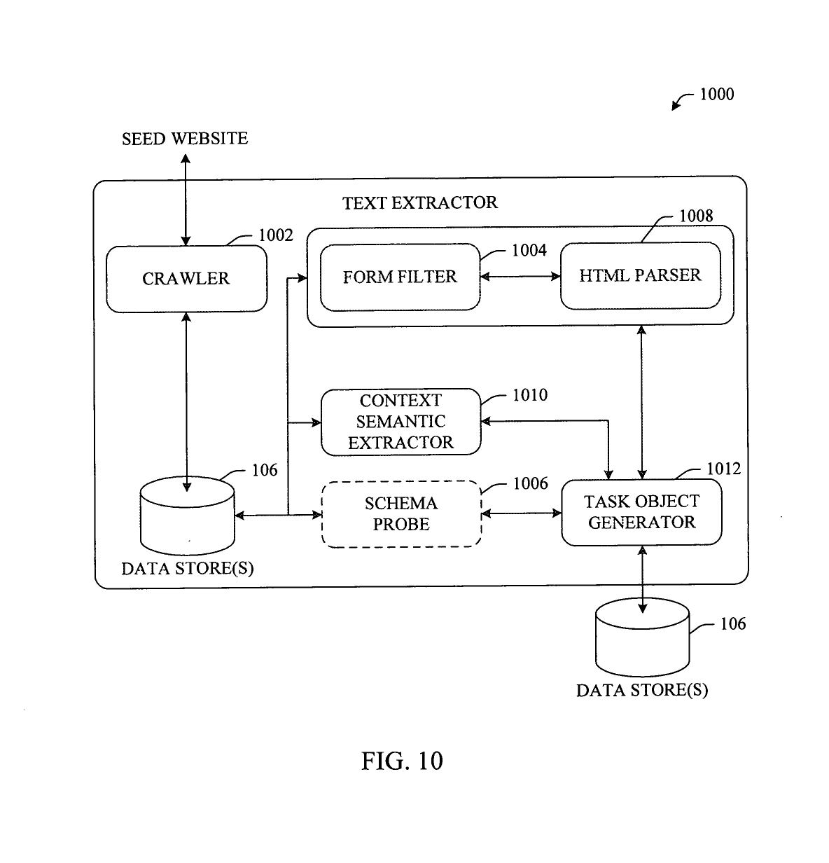

In another aspect and as illustrated in FIG. 10, the authoring/analysis component 102 can include a text extractor component 1000. The text extractor component 102 can facilitate analyzing a web page thereafter generating a task with respect to the website in view of a user input. In operation, the system can be employed to point to a website and automatically generate a task.

By way of example, a user can go to ABC Travel's website and the text extractor component 1000 can identify ABC Travel as a task. Within this task, the parameters (e.g., input boxes) can be automatically detected and configured. For example, destination city, arrival city, etc. can be automatically configured as input boxes. As shown in FIG. 10, it will be understood and appreciated that these parameters can be automatically discovered using, for example, a crawler.

In essence, for users who enter a search query and define an associated task, the novel innovation includes a system (e.g., browser plug-in) that basically follows the user around till the user comes across a form and fills it out with information that matches the initial query. Based on the result, the authoring/analysis component 102 can automatically submit the site as a “new task.”

As described above and as shown in FIG. 10, in the background, an Internet crawler 1002 can be employed that crawls the site and extracts the “semantic information” (fields and field values) using a variety of features such as, HTML titling, descriptions, keywords etc. With the task registered within the data store 106, the authoring/analysis component 104 can employ the initial sample query to train the “new task”.

One purpose of task extractor 1000 is to automatically extract tasks from given seed web sites. Here the system can limit the definition of tasks on form-enabled tasks, e.g., tasks that have a form as their input parameters. The output of task extractor component 1000 is a task object (.TSK) written to a task store (e.g., data store 106) which could be further utilized by authoring/analysis component 104 (e.g., task wizard).

Since task objects require fields of keywords and descriptions of tasks, one of the most important and difficult parts in task extractor 1000 can be discovering the semantic information about the task, that is, the functionality of this task for end users. One step further, the task extractor component 1000 can define a description that users would enter when they want to perform a particular task.

In accordance therewith, this mapping can be addressed in a number of manners. In one example, the system can discover information form the HTML form and its context. In another approach, the system can apply a query probing technique to the data store 106. Given a seed website, which is identified as containing common tasks beforehand, a crawler 1002 can first crawl the web pages under this seed web site and write them into a database (e.g., data store 106). Also, the crawler 1002 can record the linkage or mapping between different web pages in another table, for the reason that the links to and from a web page may induce some semantic information for tasks on the web page.

A form filter 1004 and schema probe 1006 can employ the web page information in the database as input. One function of form filter 1004 is to extract HTML forms from HTML raw text via an HTML parser 1008. Furthermore, if possible, the form filter should filter out forms having the same functionality or pointing to the same action, which is often the case for web pages under the same web site. A simple example for this situation is that there could be many pages having Google™ Search form, but only a single task object is desired in our task store. However, this problem could become more difficult for the same task residing in different web sites.

The form filter 1004 can pass filtered forms an HTML parser 1008, and then the HTML parser 1008 can extract structured information of the forms, including action URI, method, input type, etc. Moreover, the default value for INPUT in HTML forms may provide information about the slot entity. The context semantic extractor 1010 can capture the information other than that in HTML tags.

It will be appreciated that the system can capture both slot-level information as well as task-level information. For example, words that appear right in front of an INPUT element are highly possible to bring in slot-level information for it. On the other hand, the TITLE of a web page or words right before or after the form may provide task-level information. However, it is likely that simply extracting information in certain contextual positions does not show good performance. In this case, the system can use all the data on the web page as a richer context, which at the same time can bring in some unwanted noise.

A weighted importance model for data on the same web page may be introduced to address this noise-filtering / relevant information extraction issue. Importance can depend on the distance from the form, or the IDF of that word, etc. One feature of the schema probe 1006 is to provide more information about the entities for slots. It is often difficult to get the entity for each slot by simply crawling the web page, since the value for the slot does not exist in web page.

Logs from seed web sites can assist in alleviation of this problem. The optional schema probe component 1006 can automatically generate a query and obtain feedback or more description about slot entities. At last, for each form, the task object generator 1012 can collect all the task information from HTML parser 1008, context semantic extractor 1010, and optional schema probe 1006 to create a task object which can be stored in task store or data store 106.

As described above, the user input can be facilitated through a voice user interface (VUI) or a graphical user interface (GUI) (sometimes referred to as a natural user interface (NUI)). Referring first to a VUI aspect, in one aspect, the user can interact through a microphone (or PDA phone, etc.) to effect initiation of authoring tasks (and slot associations related thereto) within an application space. In operation, the application can have models loaded which are recognized and evaluated against as determined at call flow authoring time. The input can flow across the system through a speech interface object which is associated with a recognition object interface.

The input can then turn into a speech text lattice from a recognition engine from which the most likely lattice interpretation is selected. This can then fed into the NUI input interface defined below. The interaction model is then defined by the application space and governed by the task execution space and its call routing and dialog flow implementation. The implementations and interactions can be instrumented for feedback—both implicit and explicit.

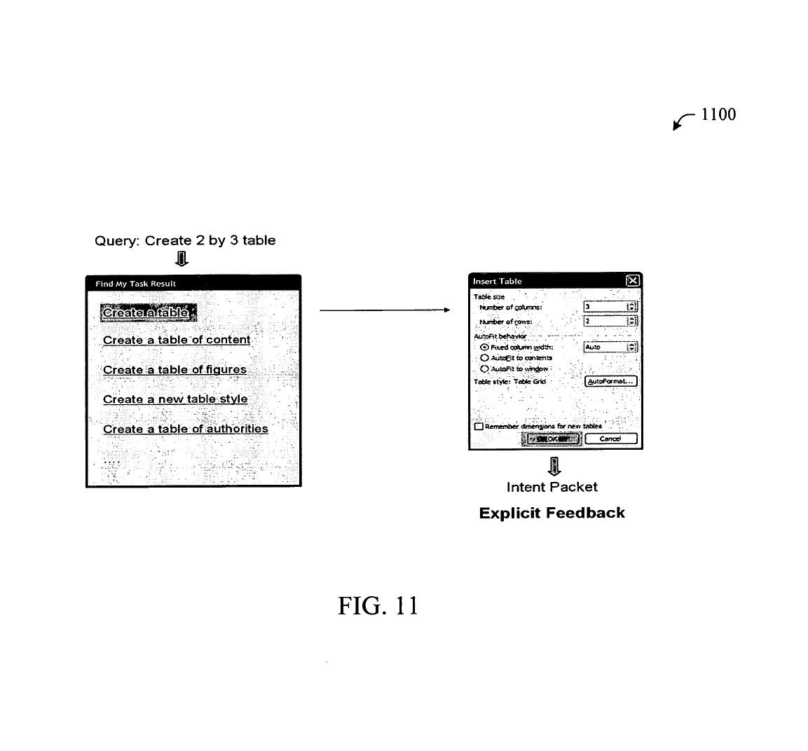

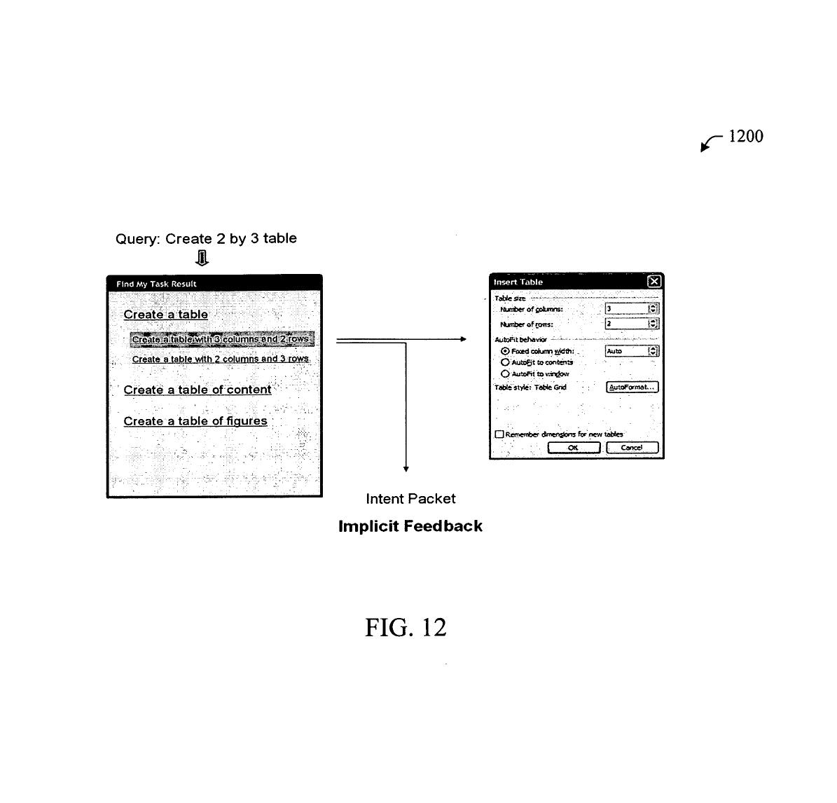

Turning now to a GUI authoring example, FIGS. 11 and 12 illustrate screen shots of a walkthrough of creating a table. FIG. 11 illustrates an explicit feedback example with respect to creating a table in accordance with an aspect of the innovation. In particular, the walkthrough starts with creating a two by three table. In operation, the user types “create two by three table” as an input query. The system can employ the lexical processing component, e.g., 402 of FIG. 4, thereby analyzing the query input and separating the query into tokens, “create” “two” “by” “three” and “table”.

Accordingly, the system can recognize that “two” and “three” are integers using the named entities mechanisms. Next, the system can find the best tasks available by employing the statistical task search component, e.g., 404 of FIG. 4. For example and as illustrated in FIG. 11, the system can return, create a table, create a table of contents, etc.

Here, a user can click on the “create a table” link that opens the insert table dialog. As shown, the system can auto-fill boxes based upon a slot filling result (e.g., statistical slot filling 406 of FIG. 4). When the user acknowledges by depressing “OK”, the particular action can send back an intent packet or “explicit feedback” of what the user did in connection with the initial input query. In this case, the input query was “create two by three table”, the number of columns was three and the number of rows was two.

As a result, the system can learn that “two by three” maps to rows by columns. Given a number of users, the system can train a model that functions based upon probability weights associated therewith.

In the aspect of FIG. 11, the user can type or click on the GUI elements that help provide the needed input to navigate or command the application space. It will be understood that the input can be effectuated via any suitable device, including but not limited to, mouse clicks (e.g., selection/de-selection) or keyboard input (e.g., control keys or textual input).

In an alternative aspect and with reference to FIG. 12, the task result can present to the user optional slot filling alternatives as shown. Again, this is up to the application to figure out what the results look like and what information it presents. As shown, alternative hypotheses of what 2 by 3 means can be displayed. After a user clicks on an option, the GUI element can open with the rows and columns filled in automatically. As well, “implicit feedback” can be sent back in the form of an intent packet that identifies a user preference of 3 columns and 2 rows over 2 columns and 3 rows. It will be appreciated that this implicit feedback is not as definite as the explicit feedback of FIG. 11 where the user depresses “OK” to acknowledge the auto-slot fill. Rather, in the aspect of FIG. 12, the system sends the implicit feedback simultaneously with rendering the GUI dialog element. In other words, the feedback is sent prior to the user reviewing the auto-filled information in the insert table dialog box.

In accordance with an alternative aspect, the system 100 can employ an artificial intelligence (AI) component which facilitates automating one or more features in accordance with the subject innovation. The subject innovation (e.g., in connection with task selection) can employ various AI-based schemes for carrying out various aspects thereof. For example, a process for determining which task to select based upon an input query can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of database systems, for example, attributes can be words or phrases or other data-specific attributes derived from the words (e.g., database tables, the presence of key terms), and the classes can be categories or areas of interest (e.g., levels of priorities).

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., näive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to map to a particular task, which task to select.

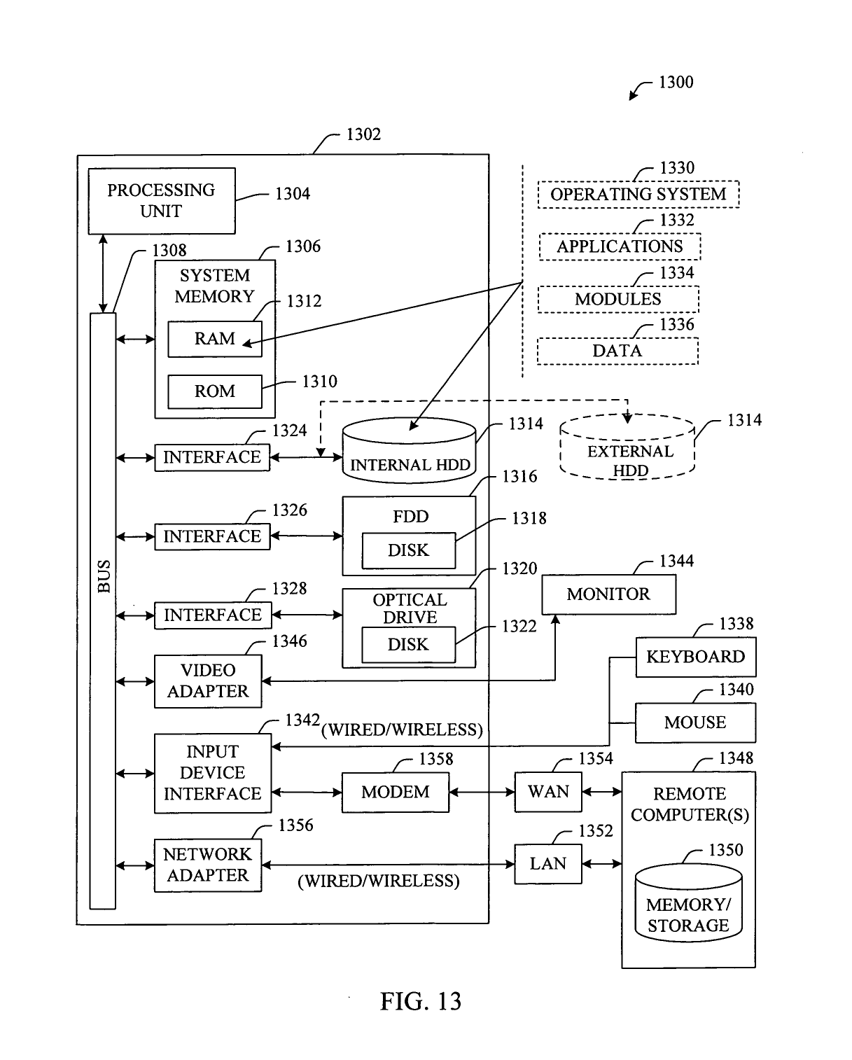

Referring now to FIG. 13, there is illustrated a block diagram of a computer operable to execute the disclosed adaptive semantic platform architecture. In order to provide additional context for various aspects of the subject innovation, FIG. 13 and the following discussion are intended to provide a brief, general description of a suitable computing environment 1300 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the exemplary environment 1300 for implementing various aspects of the innovation includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

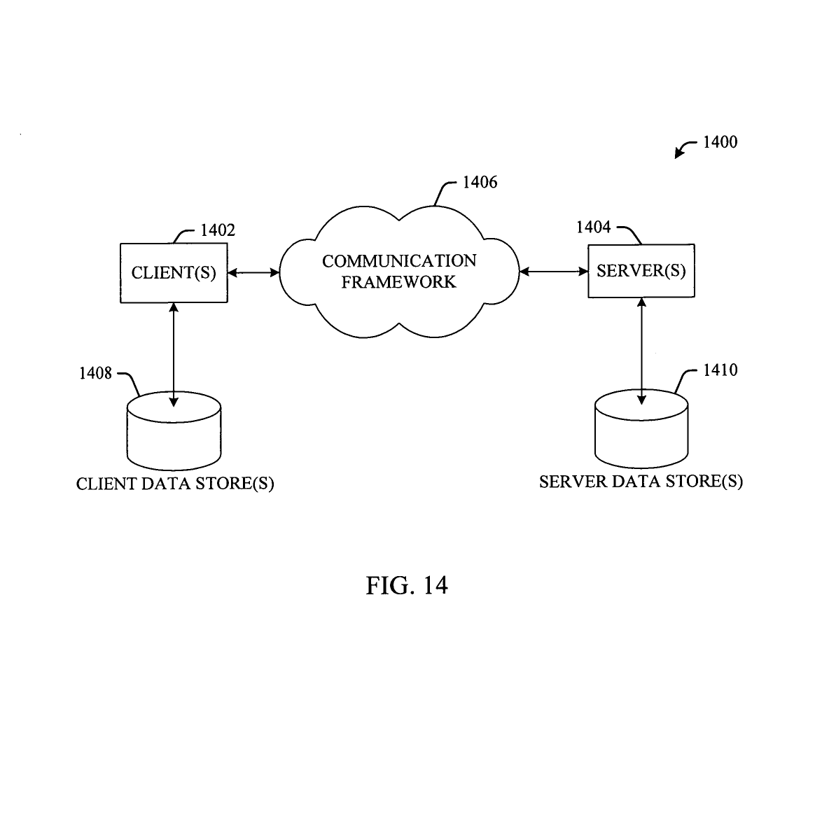

Referring now to FIG. 14, there is illustrated a schematic block diagram of an exemplary computing environment 1400 in accordance with the subject innovation. The system 1400 includes one or more client(s) 1402. The client(s) 1402 can be hardware and/or software (e.g., threads, processes, computing devices). The client(s) 1402 can house cookie(s) and/or associated contextual information by employing the innovation, for example.

The system 1400 also includes one or more server(s) 1404. The server(s) 1404 can also be hardware and/or software (e.g., threads, processes, computing devices). The servers 1404 can house threads to perform transformations by employing the innovation, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates intuitive interaction between a human and a machine, comprising:
an authoring/analysis component (104) that facilitates generation of a plurality of assets each having a plurality of parameters that are mapped to an input criteria; and
a reasoning component (102) that statistically analyzes the input criteria and renders an asset based at least in part upon the input criteria.

2. The system of claim 1, the authoring/analysis component (104) gathers feedback based at least in part upon the input and the rendered asset.

3. The system of claim 2, the authoring/analysis component (104) learns from the feedback and infers a user intent based at least in part upon the feedback.

4. The system of claim 3, the reasoning component (102) selects the asset based at least in part upon an analysis of the user intent.

5. The system of claim 4, the asset is at least one of a document and an action.

6. The system of claim 1, the authoring/analysis component (104) comprises:
a task editor component (502) that enables generation of the asset and establishment of a plurality of annotations that assist the reasoning component in analysis of the input criteria; and
a training component (504) that incorporates feedback data, trains a learning model and generates an index that assists the reasoning component in selection of the asset.

7. The system of claim 6, the task editor (502) includes a text extractor (1000) that automatically generates the asset based upon an analysis of a webpage.

8. The system of claim 7, the text extractor (1000) includes a crawler (1002) that analyzes the webpage and extracts semantic information that facilitates automatic generation of the asset associated with the webpage.

9. The system of claim 6, the index includes at least one of a task index (602) and a task property (604).

10. The system of claim 7, the learning model includes at least one of a query model (606) and a slot model (608).

11. The system of claim 1, further comprising an artificial intelligence (AI) component that employs a statistical-based analysis that infers a user intent and selects the asset based at least in part upon the user intent.

12. A computer-implemented method of reacting to a user input, comprising:
authoring an asset;
determining a user intent with respect to the user input;
mapping the asset to the user input based at least in part upon the user intent;
executing the asset;
obtaining feedback; and
learning from the feedback.

13. The computer-implemented method of claim 12, further comprising rendering the asset.

14. The computer-implemented method of claim 13, the act of authoring the asset comprises generating at least one of a document and an action.

15. The computer-implemented method of claim 12, the act of authoring the asset comprises generating a task framework.

16. The computer-implemented method of claim 15, the act of authoring the asset further comprises applying a plurality of parameters to the task framework.

17. The computer-implemented method of claim 15, further comprising generating an index for the asset, the index maps the asset to a characteristic of the user input.

18. A computer-executable system that facilitates statistical-based interaction comprising:
means for authoring a plurality of assets;
means for determining a user intent based upon a user input;
means for mapping a subset of the plurality of assets to the user input based at least in part upon the user intent.

19. The computer-executable system of claim 18, further comprising means for compiling feedback based at least in part upon the subset of the plurality of assets.

20. The computer-executable system of claim 19, further comprising:
means for generating knowledge from the feedback; and
means for applying the knowledge to map the subset of the plurality of assets to a disparate user input.
